(19) United States
(12) Patent Application Publication
(10) Pub. No.: US 2024/0224991 A9
(43) Pub. Date: Jul. 11, 2024

(54) NANO-DISPERSION COMPRISING CELLULOSE NANOCRYSTAL AS PESTICIDE/FUNGICIDE CARRIERS FOR AGRICULTURE AND AQUACULTURE

(71) Applicants: Michael Kam Chiu Tam, Waterloo (CA); Chunxia Tang, Wuxi (CN); Juntao (Reynard) Tang, Changsha (CN); Dae Sung Kim, Daejeon (KR); Fatemah Haji, Aurora (CA); Gaili Cao, Waterloo (CA)

(72) Inventors: Michael Kam Chiu Tam, Waterloo (CA); Chunxia Tang, Wuxi (CN); Juntao (Reynard) Tang, Changsha (CN); Dae Sung Kim, Daejeon (KR); Fatemah Haji, Aurora (CA); Gaili Cao, Waterloo (CA)

(21) Appl. No.: 18/492,435

(22) Filed: Oct. 23, 2023

Related U.S. Application Data
(60) Provisional application No. 63/475,168, filed on Oct. 21, 2022.

(51) Int. Cl. A01N 25/04; A01N 25/10

(52) U.S. Cl. CPC A01N 25/04; A01N 25/10; A01N 53/00

(57) ABSTRACT

The present disclosure describes compositions and methods for preparing aqueous nano-dispersions of hydrophobic agrochemicals and fungicides comprising cellulose nanomaterials as a carrier or dispersing agent. The compositions described herein provide superior pest and parasite control efficiency. The disclosure also provides pesticide formulations comprising cellulose nanomaterials and a dispersing agent, e.g., a surfactant, that demonstrates enhanced deposition on hydrophobic plant surfaces. The disclosure also describes the design and preparation of mucoadhesive CNC pesticide containing nano-dispersion for the control and remediation of parasitic organisms, such as sea lice in farmed aquatic species such as salmon.

### CROSS-REFERENCE TO RELATED APPLICATION

The present application claims the benefit under 35 U.S.C. 119(e) of U.S. Provisional Patent Application Ser. No. 63/475,168, entitled: Nano-Dispersion Consisting of Cellulose Nanocrystals as Pesticide/Fungicide Carriers for Agriculture and Aquaculture, filed on 21 Oct. 2023, which is incorporated herein by reference in its entirety.

### BACKGROUND

Field of the disclosure. The present disclosure relates to the field of agrochemical compositions, formulations and deposition, and the use of mucoadhesive CNC-pesticide dispersion for agriculture and/or aquaculture. Also described, is a sustainable (i.e., “green”) process to prepare aqueous nano-dispersion of hydrophobic agrochemicals that display excellent deposition behavior using sustainable nanoparticles as carriers for pest and parasite control using these formulations.

Background information Agrochemicals (e.g., pesticides, herbicides, and fungicides) play an important role in crop protection with millions of tons consumed around the world each year.^{[1]} However, the poor water solubility of many agrochemicals greatly limit their wide applications.^{[2]} Many strategies were applied to address the solubility issue using toxic organic solvents and surfactants to solubilize or disperse the agrochemicals. Therefore, environmental pollutions associated with the application of such pesticide formulations via spraying have become a major environmental and health challenge.^{[3]}

Numerous hydrophobic delivery formulations, such as synthetic polymeric micelles, amphiphilic polymers, and liposomes have been developed to stabilize hydrophobic compounds, such as pesticides, fungicides and pharmaceutical drugs.^{[4]} Emamectin benzoate (EMB), a macrocyclic lactone biological insecticide produced from avermectin Bi via a fermentation process, has an ultra-high efficiency in a wide spectrum, low toxicity, and is approved by food and drug administration (FDA) for the treatment of parasitic infection. However, the poor water solubility of EMB (˜24 mg/L) has resulted in a low bioavailability at target sites. To enhance the water solubility of EMB, various nanotechnology strategies have been employed. For example, Yang et al. prepared a solid nanodispersion containing 15% (w/w) of EMB using the solidifying nanoemulsion method.^{[5]} Shoaib et al. prepared an EMB nano-formulation using polymeric nanocapsules (PNC), mesoporous nanosilica (MCM-48), and silicon dioxide nanoparticles (SNPs). They confirmed that the nanoformulation enhanced UV stability and colloidal behavior as well as providing good insecticidal activity against Plutella xylostella.^{[6]} Wang et al. fabricated microspheres using various surfactants via the microemulsion polymerization method for EMB controlled release. PVA was also used as an emulsifier to tune the morphology, average size, dispersity, and stability of the EMB microsphere.^{[7]} However, the current EMB encapsulation techniques require complicated synthetic procedures, non-ecofriendly synthetic agents, and they display low drug loading and encapsulation efficiencies.

With the development of nanotechnology and material science, the design and preparation of environmentally friendly nano-sized pesticide formulations is a key focus of sustainable agriculture.^{[8]} Due to its large surface area, nanoparticles are widely used as a carrier for the delivery of various chemicals (like drugs, pesticides, herbicides, etc.) and therapeutic agents.^{[9-13]}

Nanoparticles as a delivery system is especially promising for pesticides, which could replace conventional emulsifiable concentrates, thus reducing or eliminating the organic solvent in agricultural formulations with enhanced performance.^{[14]} There are reports on the applications of micro/nanoparticles as carriers for agrochemicals in the preparation of the these agrochemical formulations. The specific nanoparticles consisted of silica, sodium alginate, poly (lactic-co-glycolic acid), cellulose derivatives, chitosan and derivatives, lignin, etc.^{[8, 15-18]}

Biomass derived nanocarriers are sustainable, biodegradable and environmentally friendly, thus they are highly desirable as alternative green carriers for these compounds, replacing emulsion products formulated using toxic organic solvents for pesticide/herbicide applications.^{[10]}

Moreover, the deposition of pesticide formulations on hydrophobic surface is critical to ensure the efficiency of the delivery of agrochemicals. After spraying an agrochemical formulation onto the plants, the droplets tend to bounce, splash and runoff from the plant surface due to the hydrophobic chemicals and the nano/micro roughness on plant surfaces.^{[19]} Much effort has been devoted to regulating the droplet impact on hydrophobic plant surfaces, and surfactant addition has proven to be the most efficient and simple scheme owing to the high surface-active property. However, it requires concentrated surfactants to achieve a significant deposition on a plant surface and sometimes the surfactant concentration can be several times higher than its critical micelle concentration,^{[20]} thereby increasing the risk of environmental pollution and cost.

Sodium dodecyl sulfate (SDS), a common anonic surfactant, has been widely used in many applications, but it has poor performance in terms of controlling the droplet deposition on hydrophobic plant surface even at high surfactant concentration.

Therefore, there is still an unmet need in the art for facile, ecofriendly, and more effective agrochemical encapsulation compositions and methods that overcome one or more of the well-known limitations of the art.

### SUMMARY

The present disclosure provides a composition and a process for preparing agrochemical nano-dispersion, accordingly with a method for target organism control using such nano-dispersions for agriculture and/or aquaculture applications. In as aspect, the composition comprises a water-insoluble active ingredient, e.g., a hydrophobic agrochemical, and a hydrophilic biomass-based polymer/nanoparticle.

In an additional aspect, the disclosure provides a method comprising the steps of: (a) dissolving an agrochemical in an organic solvent; (b) dispersing a biomass-based polymer/nanoparticle in an aqueous or organic medium; (c) mixing components from step (a) and step (b); (d) removal of all organic solvents to produce concentrated agrochemical/biomass-based aqueous dispersion, or wettable dry powder (e.g., if all the solvents are completely removed).

In an additional aspect, the disclosure provides a method for targeted organism control comprising the steps of: (1) diluting the concentrated agrochemical/biomass-based aqueous dispersion or redispersing the dried powder sample from step (d) with water, and (2) applying the dispersion from step (1) to a plant surface or to the targeted organism.

In an additional aspect, the disclosure provides a mucoadhesive nanocapsule comprising cellulose nanocrystals (CNC) and chitosan (CS) that can encapsulate an insoluble agrochemical, e.g., EMB, with high efficiency. In an additional aspect, the disclosure provides the fabrication of a CNC/CS nanocapsule, and provide a facile, reproducible, and ecofriendly technique for the stabilization of hydrophobic compounds using nano-polysaccharides. The compositions and methods described herein can improve the functionality and therapeutic effect for various nano-enabled delivery systems in the agriculture and aquaculture sectors.

In an additional aspect, the disclosure provides a stable and efficient agrochemical formulation comprising CNC modified by poly(diallyldimethylammonium chloride) (PDADMAC) and sodium dodecylsulfate (SDS), and method of making the same. The method comprises the steps of: (a) adding Polydiallyldimethylammonium chloride (PADAMAC) solution into CNC dispersion and magnetically stirring for 24 h; (b) removing unreacted PADAMAC via ultrafiltration to obtain PADAMAC modified CNC dispersion (PCNC dispersion); (c) removing PCNC dispersion obtained from (b) and freeze-dry it to determine its concentration; (d) dissolving SDS in water to form an SDS solution; (e) adding SDS solution into PCNC dispersion obtained from (b) under magnetic stirring then stirring for 5 h to obtain SDS/PCNC complexes; and (f) adding targeted agrochemicals into the dispersion from (e) and magnetically stirring for 12 h.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating an embodiment of the invention and are not to be construed as limiting the invention. Further objects, features and advantages of the invention will become apparent from the following detailed description taken in conjunction with the accompanying figures showing illustrative embodiments of the invention, in which:

FIG. 1 Schematic illustration of the concept of the present invention.

FIG. 2A and FIG. 2B. (A) Transmittance of CNC-DEL_{X} nano-dispersion as a function of DEL dose (g). Inserted picture showing the 0.45 wt % nano-dispersions with different DEL dose (g). (B) average hydrodynamic diameter of CNC-DEL_{X}

FIG. 3A, FIG. 3B and FIG. 3C. Optical pictures of mealworms mortality in real time (A), the living mealworms ratio of 0.1 wt % CNC-DEL, 0.5 wt % CNC-DEL, and 1.0 wt % CNC-DEL dispersion as a function of time, and the inserted picture showing the three dispersions (B), the living mealworms ratio of 1.0 wt % CNC, DEL control, and 1.0 wt % CNC-DEL dispersion as a function of time, and the inserted picture showing the three dispersions (C).

FIG. 4A, FIG. 4B, and FIG. 4C. Mealworms mortality of 0.1 wt % CNC-PER, 0.5 wt % CNC-PER, 1.0 wt % CNC-PER and commercial (100 ppm PER) dispersion as a function of time.

FIG. 5A, FIG. 5B, and FIG. 5C. Optical picture of mortality of waxworms treated with 1.5 wt % CNC-PER and commercial (150 ppm PER) at different time (A), living waxworm ratio of the two samples in real time (B), and picture showing the two formulations (C).

FIG. 6A, FIG. 6B, FIG. 6C, FIG. 6D, and FIG. 6F. Field trial test of CNC-DEL nano-dispersion in Asiatic Agriculture Industrial Pte Ltd.

FIG. 7. A schematic illustration for synthesis method of CPEC.

FIG. 8. An optimal image of the dispersion of A) CE nanoparticles in water (10 mg-100 mg EMB content, control: pure CNC suspension), B) CPEC at different mass ratio 1:50 to 1:0.7 (CS:CNC, w/w).

FIG. 9A, FIG. 9B, and FIG. 9C. A) Schematic illustration of colloidal stability of CPE20, CPE80, and CPEC80, B) particle size and zeta potential of CEC (20-80 mg) and C) CPEC nanoparticles.

FIG. 10. The different morphology of modified CNC/Gch nanocapsule depending on synthesizing method: 1) introduce CNC/PVP into Gch solution, 2) introduce Gch into CNC/PVP solution, scale bar: 500 nm.

FIG. 11A, FIG. 11B, FIG. 11C, and FIG. 11D. Fluorescence image of CPEC on zebrafish: A) tail, B) skin, C) head; bar scale is 100 μm; D) a stitched image of fluorescence on zebrafish skins after 30 mins of CPEC exposure.

FIG. 12, FIG. 12B, FIG. 12C, and FIG. 12D. A) The advancing and receding contact angles and contact angle hysteresis on eggplant skin; B) the change of contact angle of SDS/PCNC complexes on eggplant with time; C) the viscosity-shear rate of SDS/PCNC complexes; D) the surface tension of SDS/PCNC complexes.

FIG. 13A, FIG. 13B, FIG. 13C, and FIG. 13D. A) Droplet impact on eggplant skin with speed of 2.4 m/s from side view; B) droplet impact from oblique view; C) dimeter change of the droplet with time; D) height change of droplet with time.

FIG. 14A, FIG. 14B, FIG. 14C, FIG. 14D. A) Droplet impact on hydrophobic surface produced by beeswax/SDS emulsion with speed of 2.4 m/s from side view; B) droplet impact from oblique view; C) dimeter change of the droplet with time; D) height change of droplet with time.

FIG. 15A, and FIG. 15B. A) Visual picture of Azoxytrobin-SDS/PCNCformulation with varying concentration; B) Droplet diameter of these formulations on eggplant skin.

### DETAILED DESCRIPTION

While various embodiments of the present disclosure are described herein, it will be understood by those skilled in the art that such embodiments are provided by way of example only. It will be understood by those skilled in the art that numerous modifications and changes to, and variations and equivalent substitutions of, the embodiments described herein can be made without departing from the scope of the disclosure. It is understood that various alternatives to the embodiments described herein may be employed in practicing the disclosure, and modifications may be made to adapt a particular structure or material to the teachings of the disclosure. It is also understood that every embodiment of the disclosure may optionally be combined with any one or more of the other embodiments described herein which are consistent with that embodiment.

Where elements are presented in list format (e.g., in a Markush group), it is understood that each possible subgroup of the elements is also disclosed, and any one or more elements can be removed from the list or group.

It is also understood that, unless clearly indicated to the contrary, in any method described or claimed herein that includes more than one act or step, the order of the acts or steps of the method is not necessarily limited to the order in which the acts or steps of the method are recited, but the disclosure encompasses embodiments in which the order is so limited.

It is further understood that, in general, where an embodiment in the description or the claims is referred to as comprising one or more features, the disclosure also encompasses embodiments that consist of, or consist essentially of, such feature(s).

It is also understood that any embodiment of the disclosure, e.g., any embodiment found within the prior art, can be explicitly excluded from the claims, regardless of whether or not the specific exclusion is recited in the specification.

Headings are included herein for reference and to aid in locating certain sections. Headings are not intended to limit the scope of the embodiments and concepts described in the sections under those headings, and those embodiments and concepts may have applicability in other sections throughout the entire disclosure.

All patent literature and all non-patent literature cited herein are incorporated herein by reference in their entirety to the same extent as if each patent literature or non-patent literature were specifically and individually indicated to be incorporated herein by reference in its entirety.

Unless otherwise defined, all technical and scientific terms used herein have the same meaning as commonly understood by one of ordinary skill in the art to which this invention belongs.

Where a range of values is provided, it is understood that each intervening value between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The term “exemplary” as used herein means “serving as an example, instance or illustration”. Any embodiment or feature characterized herein as “exemplary” is not necessarily to be construed as preferred or advantageous over other embodiments or features.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

The term “about” or “approximately” means an acceptable error for a particular value as determined by one of ordinary skill in the art, which depends in part on how the value is measured or determined. In certain embodiments, the term “about” or “approximately” means within one standard deviation. In some embodiments, when no particular margin of error (e.g., a standard deviation to a mean value given in a chart or table of data) is recited, the term “about” or “approximately” means that range which would encompass the recited value and the range which would be included by rounding up or down to the recited value as well, taking into account significant figures. In certain embodiments, the term “about” or “approximately” means within 10% or 5% of the specified value. Whenever the term “about” or “approximately” precedes the first numerical value in a series of two or more numerical values or in a series of two or more ranges of numerical values, the term “about” or “approximately” applies to each one of the numerical values in that series of numerical values or in that series of ranges of numerical values.

Whenever the term “at least” or “greater than” precedes the first numerical value in a series of two or more numerical values, the term “at least” or “greater than” applies to each one of the numerical values in that series of numerical values.

Whenever the term “no more than” or “less than” precedes the first numerical value in a series of two or more numerical values, the term “no more than” or “less than” applies to each one of the numerical values in that series of numerical values.

The term “nano-dispersion” used herein refers to the dispersion of nanoparticles comprising active ingredients that are bound to a water dispersable carrier in water. In particular, the nanoparticles possess a particle size in the range of from about 10 nm to about 500 nm. The “nano-dispersion” is different from “suspension concentrate” prepared by milled active ingredient particles of 1 to 10 microns and surfactants as stabilizers. “Nano-dispersion” is distinguishable from an “emulsion concentrate”, where the active ingredient is dissolved in an organic solvent immiscible with water and the solution is mixed with water containing surfactant as emulsifiers. “Nano-dispersion” is the final product for agriculture pest control application suitable for use by the end users.

The term “PCNC dispersion” used herein refers to the dispersion of PADAMAC modified CNC. As used herein, “SDS/PCNC complexes” refers to SDS and PCNC dispersion without any agrochemicals.

The present disclosure provides a composition and a process for preparing agrochemical nano-dispersion, and methods for targeted organism control using such nano-dispersions for agriculture and/or aquaculture applications. In an aspect, the composition comprises a water-insoluble active ingredient, e.g., a hydrophobic agrochemical, and a hydrophilic biomass-based polymer/nanoparticle. As used herein, unless the context indicates otherwise, the term “agrochemical” is intended to be inclusive of compounds used for agriculture and/or aquaculture applications.

In accordance with the present disclosure, a composition and a process for preparing agrochemical nano-dispersion and a method for target organisms control using such dispersions is provided. Additionally, mucoadhesive fungicide loaded cellulose nanocrystals (CNCs) are produced that are capable of binding to the skin of aquatic organisms, such as salmon to inhibit the proliferation of parasites (e.g. sea lice). Additionally, a homogeneous agrochemical formulation with efficient deposition characteristic on hydrophobic plant surface is described.

In an additional aspect, the disclosure provides a method comprising the steps of: (a) dissolving an agrochemical in an organic solvent; (b) dispersing a biomass-based polymer/nanoparticle in an aqueous or organic medium; (c) mixing components from step (a) and step (b); (d) removing of all organic solvents to produce concentrated agrochemical/biomass-based aqueous dispersion, or wettable dry powder (e.g., if all the solvents are completely removed).

In an additional aspect, the disclosure provides a method for targeted organism control comprising the steps of: (1) diluting the concentrated agrochemical/biomass-based aqueous dispersion or redispersing the dried powder sample from step (d) with water, and (2) applying the dispersion from step (1) to a plant surface or to the targeted organism.

In an additional aspect, the disclosure provides a mucoadhesive nanocapsule comprising cellulose nanocrystals (CNC) and chitosan (CS) that can encapsulate an insoluble agrochemical, e.g., EMB, with high efficiency. In an additional aspect, the disclosure provides the fabrication of a CNC/CS nanocapsule, and provide a facile, reproducible, and ecofriendly technique for the stabilization of hydrophobic compounds using nano-polysaccharides. The compositions and methods described herein can improve the functionality and therapeutic effect for various nano-enabled delivery systems in the agriculture and aquaculture sectors.

In an additional aspect, the disclosure provides a stable and efficient agrochemical formulation comprising CNC modified by poly(diallyldimethylammonium chloride) (PDADMAC) and sodium dodecylsulfate (SDS), and method of making the same. The method comprises the steps of: (a) adding PADAMAC solution into CNC dispersion and magnetically stirring for 24 h; (b) removing unreacted PADAMAC via ultrafiltration to obtain PADAMAC modified CNC dispersion (PCNC dispersion); (c) removing PCNC dispersion obtained from (b) and freeze-dry it to determine its concentration; (d) dissolving SDS in water to form an SDS solution; (e) adding SDS solution into PCNC dispersion obtained from (b) under magnetic stirring then stirring for 5 h to obtain SDS/PCNC complexes; and (f) adding targeted agrochemicals into the dispersion from (e) and magnetically stirring for 12 h.

Moreover, the deposition of pesticide formulations on hydrophobic surface is critical to ensure the efficiency of the delivery of agrochemicals and the protection of the environment. After spraying of agrochemical formulation onto the plants, the droplets tend to bounce, splash and runoff from the plant surface due to the hydrophobic chemicals and the nano/micro roughness on plant surfaces.^{[19]} Much effort has been devoted to regulating the droplet impact on hydrophobic plant surfaces, and surfactant addition has proven to be the most efficient and simple scheme owing to the high surface-active property.^{[20]} However, it requires concentrated surfactants to achieve a significant deposition on plant surface and sometimes the surfactant concentration can be several times higher than its critical micelle concentration,^{[20]} thereby increasing the risk of environmental pollution and cost.

Sodium dodecyl sulfate (SDS), a common anonic surfactant, has been widely used in many applications, but it has poor performance in terms of controlling the droplet deposition on hydrophobic plant surface even at high surfactant concentration.^{[20]}

For some surfactants, after intercalating with the nanoparticles, surface activity is improved at lower surfactant concentration, which could be demonstrated by the lower surface tension at lower surfactant concentration.^{[21]} Such strategy is critical to enhance the droplet deposition on the plant surface using small amounts of surfactant.

Considering the negatively charged sites on cellulose nanocrystals, a cationic polymer, poly(diallyldimethylammonium chloride) (PDADMAC) is used to transform the negative cellulose nanocrystal into positively charged nanoparticles.

In any aspect or embodiment described herein, the agrochemical comprises a water-insoluble compound comprising a pesticide, an herbicide, a fungicide or a combination thereof. In certain embodiments, the pesticide is at least one pyrethroid selected comprising β-Cyfluthrin (CAS No. 68359-37-5), Deltamethrin (CAS No. 52918-63-5), Permethrin (CAS No. 52645-53-1), Fluoxastrobin (CAS No. 361377-29-9) or a combination thereof. In any aspect or embodiment described herein, the fungicide comprises Azoxystrobin (CAS No. 131860-33-8), Difenoconazole (CAS No. 119446-68-3), fenamidone (CAS No. 161326-34-7), Pyribencarb (CAS No. 799247-52-2) or a combination thereof. In any aspect or embodiment described herein, the herbicide comprises 2,4-Dichlorophenoxyacetic acid (CAS No. 7084-86-8). In any aspect or embodiment, the pesticide comprises Emamectin benzoate (CAS No. 155569-91-8). In any aspect or embodiment, the composition as described herein comprises 2,4-Dichlorophenoxyacetic acid (CAS No. 7084-86-8) in combination with Emamectin benzoate (CAS No. 155569-91-8). In any of the aspects or embodiments, the composition as described herein comprises an effective amount of a pesticide, herbicide or fungicide to effectuate the desired effect; i.e., termination of pests, weeds, or fungus. These compounds are widely used in agriculture and aquaculture to control pests and parasites in order to enhance the productivity in these sectors.

In another aspect, the water-insoluble agrochemical is dissolved in at least one organic solvent (i.e., one or a mixture of a plurality of solvents), optionally with mechanical mixing or sonication. The principle for organic solvent selection is known to one skilled in the art, that is good solubility towards the agrochemical as well as easy to volatilize. In any aspect or embodiment, the organic solvent comprises at least one of acetone, ethanol, methanol, hexane, chloroform, etc. or a combination thereof.

In a further aspect, the agrochemical solution is added to a dispersion of biomass-based polymer/nanoparticle in an aqueous or organic medium, followed by mixing with a homogenizer, sonication or magnetic stirring. The biomass-based polymer comprises, e.g., chitosan, chitin, lignin, cellulose or their derivatives or a combination thereof. In certain embodiments, the biomass-based polymer comprises cellulose nanocrystal (CNC) and/or cellulose nanofiber (CNF). CNC and CF materials are commercially available and obtained by acid hydrolysis of native cellulose using an aqueous inorganic acid, such as sulfuric acid. Upon the completion (or near completion) of acid hydrolysis of the amorphous regions of native cellulose, individual rod-like cellulose crystallites of nanometer dimensions (commonly referred to as CNC) that are relatively insensitive to acidic environment are obtained. Typically, CNC produced from sulfuric acid hydrolysis possess a width ranging between 5 and 20 nm and length of several hundred nanometers. In certain embodiments, the said medium for dispersing CNC comprises water, ethanol, acetone or methanol, etc., or a combination thereof.

In an additional aspect, at least one organic solvent in the mixture described herein is removed by oven drying, vacuum drying or spray drying to obtain concentrated agrochemical/CNC aqueous dispersion, or wettable dry powder if the solvents are removed completely. The hydrolysis of cellulose using sulfuric acid leads to the formation of sulfate ester groups generating numerous negative charges on the surface of CNC, which promotes homogeneous dispersion of cellulose nanocrystals due to electrostatic repulsion in aqueous solutions.^{[22-24]} Recent studies on CNC have revealed that CNC is an amphiphilic nanoparticle, where the axial direction of the rings formed by —CH are hydrophobic and the hydroxyl/sulfate ester groups exposed are hydrophilic. Therefore, without being bound by any particular theory, it is hypothesized that the hydrophobic pesticides/fungicides are bound/absorb on the CNC hydrophobic domains during the evaporation of organic solvents due to the hydrophobic interaction and reduced solubility of the mixture. When dispersing the wettable dry powder and concentrated agrochemical/CNC dispersion in water to prepare the “nano-dispersion”, the hydrophilic CNC carriers are uniformly dispersed in water, carrying the absorbed hydrophobic active ingredient to water.

In an embodiment, there is provided a composition for preparing agrochemical loaded CNC. The composition comprising an agrochemical in organic solvent, wherein the amount of agrochemical is from 0 to about 100 wt %, and preferably from about 0.1 to about 10.0 wt %. In any aspect or embodiment described herein, the agrochemical is present in an amount effective to effectuate the desired result. In certain embodiments, the composition comprises an agrochemical in water, wherein the concentration of CNC in water is from about 0.01 to about 10.0 wt %, and preferably from about 0.25 to about 3.0 wt %. In another embodiment, the concentration of CNC in organic solvent is 0-100 wt %, and more preferably from about 1.0 to about 20.0 wt %. There is also provided a mass ratio between the agrochemical and CNC, said ratio is from 0.02 to about 6.0 wt % based on CNC dry weight, preferably from about 0.02 to about 0.20 wt %.

In certain embodiments, after mixing the agrochemical solution and CNC dispersion, the organic solvent in the mixture is removed, preferably by oven and vacuum drying. In certain embodiments, the evaporation temperature ranges from ambient temperature to about 100° C. and, more preferably, from about 30° C. to about 90° C.

As described herein, wettable dry powder or concentrated agrochemical/CNC dispersion is obtained after the solvent evaporation. Prior to application by spraying, the wettable powder or concentrated agrochemical/CNC dispersion can be re-dispersed in water by a sonicator or homogenizer to yield the nano-dispersion with a concentration from 0.1 to 10 wt %, preferably from 0.25 to 3.0 wt %. Spray methods are well-known to one skilled in the field, and generally includes spraying, pouring, hosing, or other conventional methods for applying a pesticide formulation. In certain embodiments, the target plants or crops are sprayed with the specific formulation from the present invention as many times as needed, such as every day, weekly, every two weeks, etc. depending on the pest/fungi/weed infestation. In some embodiments, the pest mortality of pesticide formulation from the present invention is compared with commercial pesticide formulations containing the same active ingredient under a similar active ingredient concentration. An advantage of the present invention is achieving comparable pest mortality when using less active ingredient compared to current commercial formulations.

In another embodiment, there is provided a method for the preparation of mucoadhesive CNC/CS nanocapsules loaded with fungicides, such as, e.g., emamectin benzoate (EMB). The mucoadhesive properties of the nanocapsules are tailored via electrostatic and hydrogen bonding from polyphenols or chitosan based systems. Described herein is a method to synthesize mucoadhesive CNC/CS nanocapsules that can encapsulate hydrophobic drugs, wherein the desirable mass ratio is between 1:1 to 1:50 (CS:CNC w/w), yielding the optimal particle size of between 100 to 500 nm, zeta potential ranging from +20 mV to +60 mV, and drug encapsulation efficiency of between 40 to 80%. The steric stabilization effect of PVP and amphiphilic CNC stabilized the colloidal system. Importantly, the CS-coating technique enhances the colloidal stability due to electrostatic intramolecular repulsion of the positively charged CS. CNC/CS nanocapsules exhibited enhanced mucoadhesive interaction with porcine mucin protein and live zebrafish mucus.

In an embodiment, the description provides an agrochemical formulation with well-deposited behavior on hydrophobic plant surfaces. In certain embodiments, the formulation comprises from about 0.01 to about 1.0 wt % of sodium dodecylsulfate (SDS), from about 0.1 to about 0.5 wt % of PADAMAC modified CNC dispersion (PCNC-dispersion) and from 0.01 to about 0.1 wt % of an agrochemical. The PCNC dispersion comprises; i.e, is produced from, from about 0.1 to about 1.0 wt % poly(diallyldimethylammonium chloride) (PDADMAC) and from about 0.01 to about 0.5 wt % CNC dispersion. PADAMAC (CAS No. 26062-79-3) is 20 wt % solution in water and its molecular weight (Mw) is 20,000-100,000 g·mol⁻¹, which is a commercially available material. Polyethylenimine (PEI) (CAS 9002-98-6) is a linear or branched polymers with molecular weight ranging from 30,000-90,000 g/mol. In certain embodiments, the agrochemical is Azoxystrobin (CAS No. 131860-33-8) but not limited to Azoxystrobin; indeed, any agrochemical described herein, known generally in the art or that becomes known can be integrated into the formulations described herein.

In another embodiment, deposition behavior of the formulation or SDS/PCNC complexes is provided. For example, a hydrophobic plant surface is provided, e.g., the skin of an eggplant, e.g., a Chinese eggplant. The eggplant skins have a thickness of about 1 mm are carefully extracted using a knife and water was used to gently remove the dust on their surface. The method of droplet impact on the plant, e.g., an eggplant or other plant, is achieved by discharging a droplet of agrochemical formulation or SDS/PCNC complexes in 100 μl of pipette that fall freely at speed of 2.4 m/s onto the plant surface or other hydrophobic surfaces. The inner diameter of pipette tip end is about 0.55 mm. The droplet impact of the agrochemical formulation or SDS/PCNC complexes on the plant surface is recorded using a high speed camera (NPX-GS6500UM) with maximum frame rate of 10,000 fbs. The hydrophobic surface is produced by spraying emulsion onto a clean glass slide. The exemplary emulsion is produced by heating 8 mL 1.0 wt % SDS water solution, 2 g of beeswax to 70° C. SDS solution can be added into molten beeswax and sonicated with a sonicate probe for 1 min to produce the emulsion. After cooling to room temperature, the emulsion is sprayed to the cleaned glass slide. The glass plate is washed with water in the sonication bath for 10 mins and illuminated by UV lamp for 15 mins. Finally, SDS on the hydrophobic surface is removed by washing with water after the hydrophobic surface is dried.

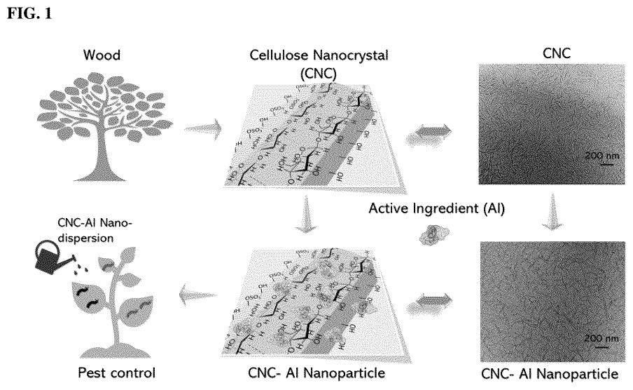

In addition, the following examples, which include embodiments of the disclosure, are given to illustrate aspects of the inventions, where CNC was obtained from Celluforce Inc. (Montreal, Quebec Canada) while other agrochemicals (pesticides and herbicides) and fungicides and solvents were purchased from Sigma-Aldrich Co. or Asiatic Agrochemicals Pte. Ltd., and used as received. The examples and accompanying figures illustrate certain exemplary embodiments as described herein and are not limiting on the scope of the disclosure. For example, FIG. 1 illustrates the general concept described herein; plant cellulose is isolated and used to prepare active ingredient-containing (e.g., pesticide, fungicide or nanoparticles that are formulated into a dispersion for treatment of plant or animal surfaces, including aquatic animals.

### Exemplary Embodiments

In an aspect, the disclosure provides methods of preparing a biomass-based nano-dispersion of a hydrophobic agrochemical comprising the steps of:
a. dissolving the hydrophobic agrochemical in at least one organic solvent;
b. dispersing biomass-based particles in an aqueous solution or at least one organic solvent;
c. mixing the solution from (a) and dispersion from (b);
d. removing the organic solvents to form an agrochecmical-biomass based product; and
e. optionally, dispersing the agrochecmical-biomass based product from (d) in water.

In any aspect or embodiment described herein, the hydrophobic agrochemical is a compound for agriculture or aquaculture applications. In any aspect or embodiment described herein, the at least one organic solvent comprises at least one of acetone, chloroform, ethanol, methanol, hexane or a combination thereof.

In any aspect or embodiment described herein, the biomass-based particles are micro- or nano-particles comprising at least one of chitosan (CS), lignin, chitin, cellulose, a polysaccharide, derivatives of the same, or a combination thereof.

In any aspect or embodiment described herein, step (d) includes removing the organic solvents by at least one of heating, vacuum, spray-drying, freeze-drying or a combination thereof.

In any aspect or embodiment described herein, the agrochemical comprises at least one of a pesticide, fungicide, herbicide, or a combination thereof.

In any aspect or embodiment described herein, the agrochemical is selected from the group consisting of Emamectin benzoate (CAS No. 155569-91-8), β-Cyfluthrin (CAS No. 68359-37-5), Azoxystrobin (CAS No. 131860-33-8) Difenoconazole (CAS No. 119446-68-3), Deltamethrin (CAS No. 52918-63-5), Permethrin (CAS No. 52645-53-1), Thiamethoxam (CAS No. 153719-23-4), 2,4-Dichlorophenoxyacetic acid (CAS No. 7084-86-8), and a combination thereof.

In any aspect or embodiment described herein, the biomass-based particles comprise at least one of cellulose nanocrystals (CNCs), cellulose microcrystals, lignin micro/nanoparticles, starch micro/nanocrystals or a combination thereof.

In any aspect or embodiment described herein, the biomass-based particles comprise a combination of CNC and CS.

In any aspect or embodiment described herein, the ratio of CS to CNC (w/w) is between about 1:1 to about 1:50.

In any aspect or embodiment described herein, the CNC/CS particles are mucoadhesive nanoparticles having a size of from about 200 nm to about 2 microns.

In any aspect or embodiment described herein, the biomass-based particles further comprise polyvinylpyrrolidone (PVP).

In any aspect or embodiment described herein, the biomass-based particles further comprise mucin. CPEC/mucin mixtures showed significant enhancement in viscosity compared to pristine CNCs, indicating enhanced mucoadhesive properties. As demonstrated herein, the mucoadhesive properties of the CPEC nanocapsule were further demonstrated using zebrafish, and the nanocapsules were successfully bound to zebrafish mucus. The mucoadhesive CPEC nanocapsule can be utilized for the treatment of mucosal infectious diseases in biomedical sectors.

In any aspect or embodiment described herein, the amount of hydrophobic agrochemical is from about greater than zero wt % to less than 100 wt % relative to the weight of the at least one organic solvent solution in step (a).

In any aspect or embodiment described herein, the amount of hydrophobic agrochemical is from about 0.1 wt % to about 10.0 wt % relative to the weight of the at least one organic solvent solution in step (a).

In any aspect or embodiment described herein, the amount of CNC is from about 0.01 wt % to about 10.0 wt % relative to the weight of the solvent in the dispersion in step (b).

In any aspect or embodiment described herein, the amount of CNC is from about 0.25 wt % to about 3.0 wt % relative to the weight of the solvent dispersion in step (b).

In any aspect or embodiment described herein, the amount of CNC is from about 1.0 wt % to about 20.0 wt % relative to the weight of the at least one organic solvent in the dispersion in step (b).

In any aspect or embodiment described herein, the amount of agrochemical in the agrochecmical-biomass based product is between about 5 wt % to about 20 wt % relative to the total weight.

In another aspect, the disclosure provides a biomass-based nano-dispersion of a hydrophobic agrochemical formed according to any of the methods described herein.

In another aspect, the disclosure provides methods of controlling a pest species comprising the steps of:

In any aspect or embodiment described herein, the surface is a plant or animal surface.
a. dispersing an effective amount of the biomass-based nano-dispersion of a hydrophobic agrochemical as described herein in water; and
b. treating or applying the dispersion from (a) to a surface or to a pest species, wherein the treatment is effective to kill or inhibit pest infestation.

In another aspect, the disclosure provides methods of preparing an agrochemical formulation comprising the steps of:
a. admixing a cationic polymer solution and a CNC dispersion (for example the solution can be magnetically stirred for 1-24 hours);
b. removing unreacted cationic polymer to obtain a polymer-modified CNC dispersion (PCNC dispersion) (for example, via ultrafiltration; also optionally freeze-drying the PCNC dispersion to determine its concentration);
c. optionally, adding a surfactant solution (for example, surfactant dissolved in water) to the PCNC dispersion (optionally, via stirring for 1-5 hours) to form surfactant/PCNC complexes; and
d. adding to (b) or (c) an agrochemical and mixing to form agrochemical-loaded surfactant/PCNC particles (optionally, via magnetic stirring for 1-12 hours).

In any aspect or embodiment described herein, the cationic polymer comprises at least one of Polydiallyldimethylammonium chloride (PADAMAC), branched and linear polyethylenimine (PEI), cationic cellulose, gelatin, dextran, polylysine, or poly[2-(dimethylamino)ethyl methacrylate] (PDMAEMA) or a combination thereof.

In any aspect or embodiment described herein, the cationic polymer is PADAMAC.

In any aspect or embodiment described herein, the mass ratio (w/w) of PADAMAC to CNC is from about 1:10 to about 10:1.

In any aspect or embodiment described herein, the surfactant comprises at least one of an anionic surfactant, a cationic surfactant, a non-ionic surfactant, a zwitterionic surfactant or a combination thereof.

In any aspect or embodiment described herein, the surfactant comprises at least one of ammonium lauryl sulfate, sodium laureth sulfate, sodium lauryl sarcosinate, sodium myreth sulfate, sodium pareth sulfate, sodium stearte, sodium lauryl sulfate, a olefin sulfonate, and ammonium laureth sulfate, trimethylalkylammonium chlorides, and the chlorides or bromides of benzalkonium and alkylpyridinium ions, fatty alcohol ethoxylate, alkyl phenol ethoxylate and fatty acid alkoxylate or a combination thereof.

In any aspect or embodiment described herein, the mass ratio (w/w) of surfactant to PCNC is from about 1:5 to about 5:1.

In any aspect or embodiment described herein, the surfactant is sodium lauryl sulfate (SLS) or sodium dodecyl sulfate (SDS).

In any aspect or embodiment described herein, the CNC comprises at least one of a sulfated CNC, glycidyltrimethylammonium chloride (GTMAC) grafted CNC, QUAB modified CNC or a combination thereof.

In any aspect or embodiment described herein, wherein the method further comprises the step of applying the agrochemical-loaded surfactant/PCNC particles to a plant surface or modified plant surface.

In any aspect or embodiment described herein, the modified plant surface comprises a plant surface treated with a beeswax/SDS emulsion.

In an additional aspect, the disclosure provides an agrochemical-loaded surfactant/PCNC particle formed according to the methods described herein.

### WORKING EXAMPLES

### Example 1. Emamectin Benzoate/CNC Nano-Dispersion Preparation

The Preparation of Emamectin Benzoate/CNC Nano-Dispersion is Described Below:
a. Dissolve 1.0 g of Emamectin benzoate in 20.0 mL of acetone by magnetic stirring.
b. Disperse 100.0 g of CNC in 80.0 mL acetone using homogenizer.
c. Mix the solution from step (a) and dispersion from step (b), followed by sonication for 5 min using sonication bath or sonication probe.
d. Place the mixture from step (c) in a vacuum oven, and remove all the acetone by vacuum at 40° C.
e. optionally, re-disperse the final powder, which is a nanocomposite of Emamectin benzoate/CNC into water to a concentration of 2 wt % to obtain a clear and well-dispersed Emamectin benzoate/CNC nano-dispersion.

### Example 2. β-Cyfluthrin/CNC Nano-Dispersion Preparation

The preparation of β-Cyfluthrin/CNC nano-dispersion is described below:
a. Dissolve 1.0 g of β-Cyfluthrin in 20.0 mL of acetone by magnetic stirring.
b. Disperse 100.0 g of CNC in 80.0 mL acetone using homogenizer.
c. Mix the solution from step (a) and dispersion from step (b), followed by sonication for 5 min using sonication bath or sonication probe.
d. Place the mixture from step (c) in a vacuum oven, and remove all the acetone by vacuum at 40° C.
e. optionally, re-disperse the final powder, which is a nanocomposite of β-Cyfluthrin/CNC into water to a concentration of 2 wt % to obtain a clear and well-dispersed β-Cyfluthrin/CNC nano-dispersion.

### Example 3. Azoxystrobin/CNC Nano-Dispersion Preparation

The preparation of Azoxystrobin/CNC nano-dispersion is described below:
a. Dissolve 1.0 g of Azoxystrobin in 20.0 mL of acetone.
b. Disperse 100.0 g of CNC in 180.0 mL deionized water, preferably with sonicator.
c. Mix the solution from step (a) and dispersion from step (b), followed by sonication for 2 min using sonication probe.
d. Place the mixture from step (c) in a vacuum oven, and remove all the acetone by vacuum under 50° C. to deposit the azoxystrobin molecules onto CNC surface which yielded a colloidal nano-dispersion of azoxystrobin/CNC nanoparticles.
e. The resultant concentrated nano-dispersion of azoxystrobin/CNC from (d) can be used directly or diluted to desired concentration, or spray-dry this dispersion to obtain a solid powder which can be readily re-dispersed in water prior to application.

### Example 4. 2,4-Dichlorophenoxyacetic Acid/CNC Nano-Dispersion Preparation

The preparation of 2,4-dichlorophenoxyacetic acid/CNC nano-dispersion is described below:
a. Dissolve 1.0 g of 2,4-dichlorophenoxyacetic acid in 10.0 mL of chloroform.
b. Disperse 100.0 g of CNC in 50 mL chloroform by a sonicator.
c. Mix the solutions from step (a) and dispersion from step (b), sonicate the mixture with sonication bath or sonication probe for 5 min.
d. Place the above mixture of 2,4-dichlorophenoxyacetic acid/CNC in a vacuum oven, and all the chloroform was removed by vacuum at room temperature.
e. optionally, re-disperse the final powder, which is a composite of 2,4-dichlorophenoxyacetic acid/CNC in water at 1 wt % concentration to obtain a clear well-dispersed 2,4-dichlorophenoxyacetic acid/CNC nano-dispersion.

### Example 5. Deltamethrin/CNC Nano-Dispersion Preparation and Tests

The preparation of deltamethrin/CNC nano-dispersion is described below:
a. Dissolve 0-6.0 g of Deltamethrin in 10.0 mL of acetone by stirring.
b. Disperse 100.0 g of CNC in 500.0 mL deionized water by sonication.
c. Mix the solution from step (a) and dispersion from step (b), then sonicate the mixture with a sonication probe or homogenize for 5 min.
d. The mixture from step (c) is subjected for evaporation in a vacuum oven under 50° C. for the deposition of deltamethrin on CNC surface. The produced colloidal and clear dispersion is denoted as CNC-DEL_{X} nano-dispersion, where the x represents the mass of deltamethrin used.

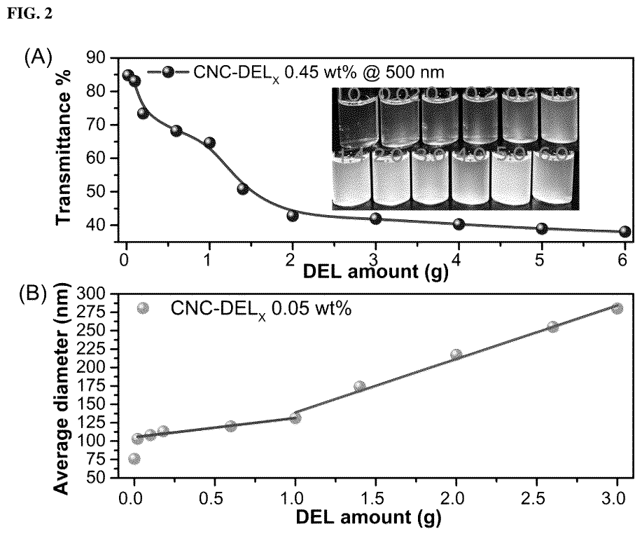

In one embodiment, the resulting CNC-DEL_{X} nano-dispersions are diluted to 0.45 wt % for turbidity test with a UV-vis spectrophotometer (Cary 100 Bio) at 500 nm. The UV transmittance (%) at 500 nm of 0.45 wt % dispersions with varying DEL dosage is shown in FIG. 2A. It is seen that 0.45 wt % CNC dispersion without DEL had a transmittance around 85%, the loss of light transmission was due to light scattering of CNC nanoparticles. The transmittance (%) decreased with increasing DEL dosage, which means turbidity was proportional to DEL dose as turbidity is inversely proportional to the transmittance (%). When DEL dosage exceeds 1.0 g, the dispersion turbidity was significantly increased as clearly seen in the optical picture (inset). The increased turbidity may be caused by the increased pesticide cluster concentration that scattered more light.

In another embodiment, the resulted CNC-DEL_{X} nano-dispersions are diluted to 0.05 wt % for particle size measurements. Although CNC is rod-like nanoparticle, the scattering from dynamic light scattering (DLS) measurements can be used to estimate the hydrodynamic diameter of the nanoparticle. DLS results at 90 degree were used as an indirect indication of changes in the particle size before and after the loading of DEL. From FIG. 2B, we can see that pristine CNC possessed an average hydrodynamic diameter of 75.9 nm, and the diameter was increased after loading DEL. When the DEL amount was below 1 g, CNC-DEL_{X} diameter increased slowly with DEL content, while the diameter increased much faster when DEL exceeded 1 g. The rate of increase is related to the formation of larger clusters during the removal of acetone when the concentrated pesticide molecules are present in the mixture. The well-dispersed CNC nanoparticles in the mixture provided uniformly distributed sites for DEL molecules to assemble, which effectively prevented the overgrowth of DEL clusters.

### Example 6. Agrochemical Nano-Dispersion Pest Mortality Study

Deltamethrin and permethrin/CNC nano-dispersions with agrochemical and CNC mass ratio of 1:100 were prepared according to the said process in example 5, and they are designated as CNC-DEL and CNC-PER, respectively. The resulting nano-dispersions were diluted to 0.1 wt %, 0.5 wt %, 1.0 wt % and 1.5 wt %, where the corresponding active ingredient concentration was around 10 ppm, 50 ppm, 100 ppm and 150 ppm. To perform the pest control test, fresh spinach leaves were spread on a petri dish (10 cm diameter), then 2 mL of the dispersion was sprayed on top (1 mL) and bottom (1 mL) of the leave surface, and 20 active worms were placed on top of the leaves. The survival rate of the works was recorded at set time intervals. In comparison, the pest control efficiency of 1 wt % CNC (0 ppm DEL) and DEL control (100 ppm DEL) were also investigated and compared with 1.0 wt % CNC-DEL (100 ppm DEL). In addition, the pest control efficiency of CNC-PER was compared with the commercial EC pesticide ORTHO® HOME DEFENSE® MAX™ under the same PER dosage.

Both permethrin and deltamethrin are wide spectrum pesticides that belong to synthetic pyrethroids pesticides. Their mode of action is mainly based on contact and stomach toxicity. The pest control efficiency of CNC-DEL and CNC-PER nano-dispersions were evaluated with two model worms, mealworms and waxworms. The said mealworms are the larval form of the mealworm beetles, and waxworms are the caterpillar larvae of wax moths.

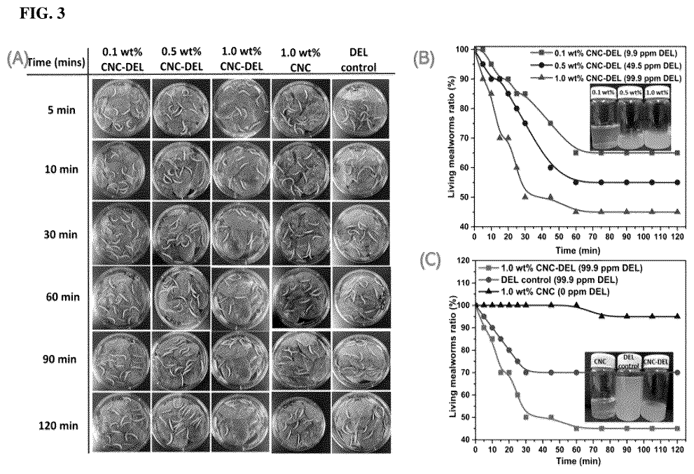

In one aspect, the pictures of mealworms treated with different concentrations of CNC-DEL and two control samples in real time is shown in FIG. 3A. The effect of CNC-DEL concentration on mealworms mortality is shown in FIG. 3B. Clearly, CNC-DEL concentration was a key factor that controlled the death ratio, as evident by the living worm ratio decreased from 65% to 45% with CNC-DEL concentration increasing from 0.1 wt % to 1.0 wt %. In addition, the 1.0 wt % dispersion displayed very fast knockdown effect, as 55% mortality was achieved in 60 mins.

In a further aspect, the mealworm mortality of 1.0 wt % CNC and DEL control that contained 0 ppm and 100 ppm DEL was investigated and compared with 1.0 wt % CNC-DEL, and the results are shown in FIG. 3C. It is seen that CNC did not show effective pest control activity, only 5% mortality was recorded during the 2 hours observation, which was probably caused by the natural death of the worms. In contrast, DEL control (100 ppm DEL) displayed an effective pest control activity, where 30% mortality was observed in 2 hours. Among the three samples, CNC-DEL possessed the strongest pest control activity under the same DEL dosage. The superior performance is probably due to the smaller size of DEL particles in CNC-DEL dispersion. At given fixed amount of pesticide, the smaller particle the larger total surface area will be achieved.

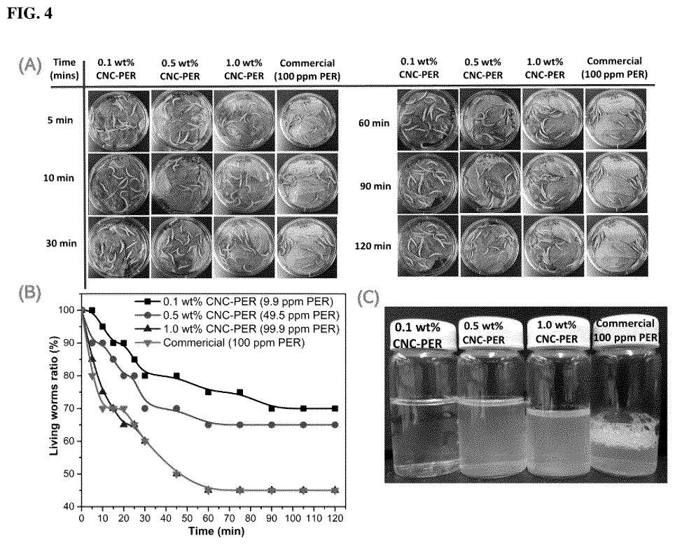

In an even further aspect, the pest control activity of CNC-PER with different concentrations were also studied and compared with the commercial EC pesticide formulation for home defense whose active ingredient is also permethrin. The results are shown in FIG. 4A-C, where we can see the concentration dominated control efficiency. Besides, when compared 1.0 wt % CNC-PER with the commercial (containing 100 ppm PER), we observed that it had comparable mortality around 55%.

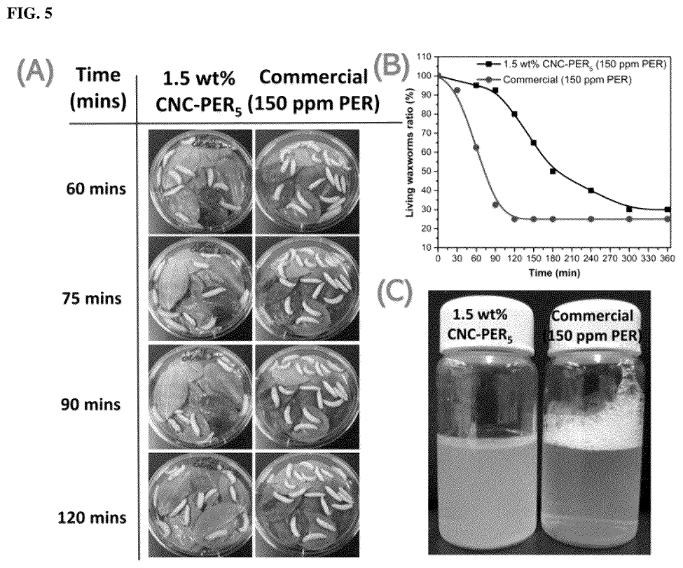

In another embodiment, a larger body weight worm, i.e. waxworm was used to assess the pest control efficiency of the nano-dispersion. The optical pictures of the mortality of waxworms treated with 1.5 wt % CNC-PER (150 ppm PER) and commercial (150 ppm PER) are shown in FIG. 5A, and the living waxworm ratio of the two samples as a function of time are shown in FIG. 5B. We can see that the commercial EC formulation displayed faster knockdown effect as 75% of the waxworms were killed in 2 hours. In contrast, the CNC-PER formulation achieved 70% mortality in 3 hours, and the death rate was slightly slower than the commercial product. The faster knockdown effect was probably due to the presence of large amount of organic solvents in commercial EC formulation. Also, we can see bubbles floated on the top of EC formulation in FIG. 5C, which was induced by the surfactants in the formulation.

Overall, the worm test results suggested that the CNC-DEL/PER nano-dispersion displayed good pest control performance, suggesting CNCs can be an ideal carrier for water-insoluble agrochemicals. Besides, the current method possesses many advantages, such as no organic solvents is presented, no surfactants involved, simple preparation process, which will satisfy the sustainable agriculture and ‘green chemistry’ concept.

### Example 7. Agrochemical Nano-Dispersion Field Trial Efficacy Test

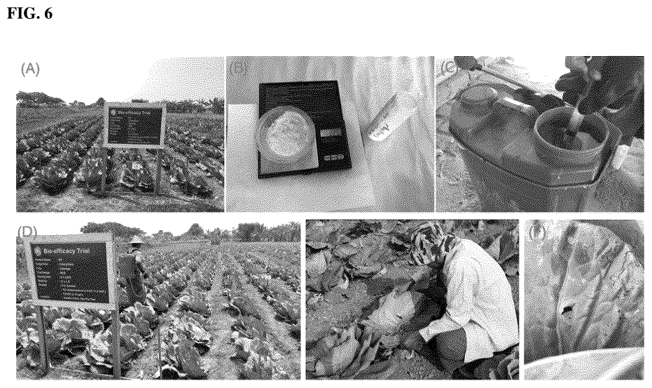

To examine the efficacy of the developed nano-dispersion, Deltamethrin was selected as a model pesticide for the field trial test, which was conducted in Pobbathiri Tsp, Nay Pyi Taw Region of Singapore during winter 2020. This field trial was made possible by Asiatic Agriculture Industrial Pte Ltd. Three plots of 4 m×3 m were designed for planting of Cabbage, Crown (hybrid), and each of them had 3 replications as shown in FIG. 6A. The efficiency of CNC-DEL nano-dispersion was compared with a commercial formulation Deltamethrin 2.5 EC for the control of Diamond back moth (DBM) in cabbage. CNC-DEL dry powder (shown in FIG. 6B) was prepared according to the procedure stated in Example 1, which was dispersed in water at a final concentration of 3.75 g/L prior to application. For comparison, Deltamethrin 2.5 EC was diluted in water with a concentration of 1.5 mL/L (seen in FIG. 6C). The spray volume was set as 100 L/acre for 2 times with a interval of 7 days, and FIG. 6D shows one of the spray experiment during the test.

Ten heads of cabbage in each plot were selected and the initial number of targeted pests per head was recorded on the 74^{th} day after planting. FIG. 6E shows one of the selected cabbage and 6F is a close view of the larvaes on the leaf. The first assessment was conducted on the 77^{th} day that was 3 days after first applications, and the second assessment was conducted on the 84^{th} day, which was 3 days after subsequent applications. The details of treatment applied for each plot is summarized in Table 1.

TABLE 1
Details of treatment for each plot.

| Application Time | T1 | T2 | T3 |
|---|---|---|---|
| 74^{th} Day | Control | Deltamethrin 2.5EC | CNC-DEL |
| | | 1.5 mL/L | 3.75 g/L |
| 81^{st} Day | Control | Deltamethrin 2.5EC | CNC-DEL |
| | | 1.5 mL/L | 3.75 g/L |

The mean number of target pest/head before and after treatment was recorded and summarized in Table 2. As shown in Table 2, cabbage plot that was treated with CNC-DEL nano-dispersion (3.75 g/L) displayed the lowest number of larvae per head, followed by that treated with Deltamethrin 2.5EC (1.5 mL/L). T1 (control plot) showed the highest number of larvae per head throughout the whole data collection and assessment period. The mortality percentage of T2 and T3 was 96% and 99% as calculated based on the mean number of target pest/head before and after treatment. It is evident that the developed CNC-DEL nano-suspension possessed comparable pest control efficiency when compared with the commercial Deltamethrin 2.5 EC formulation. In addition, the cabbage yield is shown in Table 3, where we observed a yield of T3 is 322.3 Kg, followed by T2 with 319 Kg and T1 with 294.28 Kg. Such results suggested that the developed CNC-DEL nano-dispersion is very effective to control the diamond back moth (DBM) in cabbage and further increase cabbage yield. The nano-suspension can be widely applied to other types of crops and pests by simply changing the active ingredient on CNC during the nano-suspension preparation.

TABLE 2
Mean numbers of target pest per head.

| | Initial | | |
|---|---|---|---|
| Treatment | 74^{th} day | 77^{th} day | 84^{th} day |
| T1 | 14.5 | 14.9 | 17.7 |
| T2 | 14.7 | 3.4 | 0.57 |
| T3 | 14.73 | 2.9 | 0.13 |

TABLE 3
Yield of Each Plot by 3 Replication.

| | Treatment Yield (Kg) | | |
|---|---|---|---|
| Replication No. | T1 | T2 | T3 |
| R1 | 85.2 | 102 | 103.2 |
| R2 | 99.28 | 109.2 | 117.8 |
| R3 | 109.8 | 108 | 101.3 |
| Total | 294.28 | 319.2 | 322.3 |

### Example 8. Synthesis of CEC and CPEC Nanocapsule with Loading EMB

Briefly, 1 g of CNC and 0.1 g of polyvinylpyrrolidone (PVP) (CAS Number: 9003-39-8, Mw: 10,000-360,000 g/mol) were mixed in 0.8 mL ethanol and stirred overnight. Various amounts of EMB were dissolved in 0.2 mL of ethanol. To load EMB onto the CNC/PVP nanocapsule, EMB (0.2 mL) solutions were slowly injected into the CNC/PVP solution (0.8 mL) under sonication for 5 min. Then, the mixtures were dried in an oven at 40° C. and re-dispersed in milli-Q water (200 mL) to prepare the CNC/PVP/EMB (CPE) nanoparticle suspension. Finally, the prepared CPE nanocapsule was coated with various concentration of CS. For CS coating, various concentrations of CS solution (0.01-0.6 wt. %) were prepared in 1% acetic acid. Then, the CS solutions were slowly injected into the CPE solutions using a syringe pump at a rate of 1.5 mL/min, while the solution was subjected to probe sonication. The synthesis procedure of the CNC/EMB (CEC) nanocapsule was the same as the CPEC synthesis protocol without the addition of PVP. The mass ratio between CNC and CS was calculated as shown in Table 4.

TABLE 4
Mass ratio between CS and CNC.

| Sample | 1 | 2 | 3 | 4 | 5 | 6 | 7 | 8 |
|---|---|---|---|---|---|---|---|---|
| CNC | 0.5 | 0.5 | 0.5 | 0.5 | 0.5 | 0.5 | 0.5 | 0.5 |
| (wt. %) | | | | | | | | |
| Chitosan | 0.01 | 0.02 | 0.03 | 0.04 | 0.05 | 0.1 | 0.2 | 0.4 |
| (wt. %) | | | | | | | | |
| Mass ratio | 1:50 | 1:25 | 1:17 | 1:13 | 1:10 | 1:5 | 1:2.5 | 1:1.3 |
| (CS:CNC) | | | | | | | | |

*Working volume = 10 mL, all samples contain 20 mg of EMB

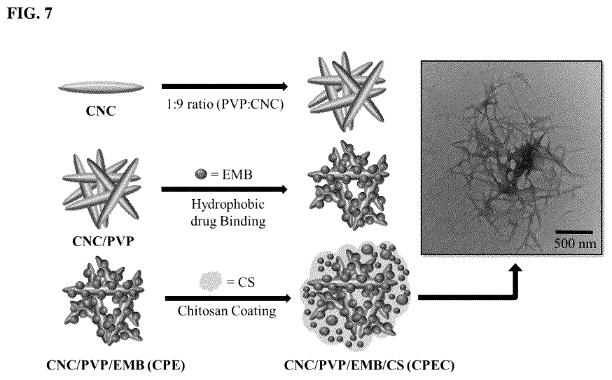

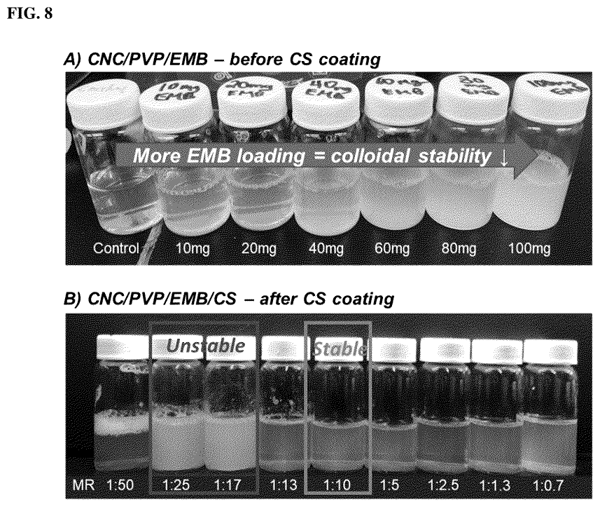

The mucoadhesive CPEC nanocapsule was synthesized as illustrated in FIG. 7. Firstly, CNC was coated with amphiphilic PVP to increase its hydrophobicity, which can increase the capacity to load hydrophobic compounds. The hydrophilic region of PVP can interact with the CNC surface, thereby increasing the hydrophobicity of the CNC surface. To coat PVP onto CNC, a 1:9 mass ratio (CNC:PVP, w/w) was used, as we previously found that 1:9 mass ratio was an optimal condition.^{[25]} Then, EMB was loaded on the CNC/PVP in ethanol. EMB possesses poor solubility in water (˜24 mg/L), but it is highly soluble in organic and polar solvents. Thus, the binding interaction in ethanol was more favorable than in water, allowing the EMB molecules dissolved in ethanol to bind to the hydrophobic region of CNC/PVP nanoparticles. Various amounts of EMB (10 to 100 mg) were evaluated for the binding capacity (FIG. 8). The pure CNC 0.5 wt. % solution (control) appeared clear and well-dispersed in water. However, the CNC/PVP/EMB solutions became more opaque with increasing amounts of EMB owing to the aggregation of the CNC/PVP/EMB complex, which indicated a poor dispersion in water (FIG. 8A). After hydrophobic drug binding, the CPE nanocapsules were coated with different concentrations of CS (0.01 to 0.6%). When the CS solutions were introduced into the aqueous CNC/PVP/EMB dispersions, a thick aggregated gel was formed due to the strong electrostatic interaction between CNC and CS. The CNC/PVP/EMB/CS (CPEC) nanocapsule showed aggressive coagulation due to strong electrostatic interaction from 1:25 to 1:17 mass ratio (CS:CNC, w/w). This flocculation occurred when the zeta potential of the system became nearly zero. However, the CPEC nanocapsule was stabilized at a 1:10 mass ratio as the dispersion became clearer (FIG. 8B). This observation suggests that the mass ratio between CNC and CS is a significant factor for the stabilization of CNC/CS nanoparticles in a colloidal system.

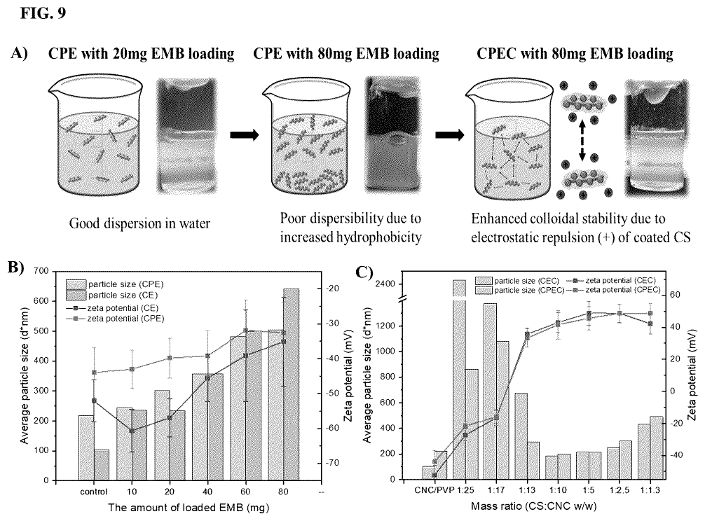

The colloidal properties of CEC and CPEC nanocapsules was evaluated with different amounts of EMB loading. CPE-20 (CPE nanocapsule loaded with 20 mg of EMB) was clear and stable in aqueous solution (FIG. 9A, left), suggesting that EMB was successfully bound to the hydrophobic region of the CNC. This indicated that the binding capacity of CNC/PVP nanocomplex was not saturated with 20 mg of EMB loading. However, when 80 mg of EMB was loaded to the CNC/PVP nanocomplex, the solution became very opaque, which was evidence of some aggregation of free EMB in the aqueous suspension. (FIG. 9A, middle) Interestingly, when we coated the CNC/PVP complex with CS, the unstable CPE-80 system was stabilized and well-dispersed in water. (FIG. 9A, right) This is probably because CS was coated onto the hydrophobic domain of CPE-80 complex, and these coated cationic CS particles electrostatically repelled each other and stabilized the colloidal system. Intramolecular repulsion of cationic CS polymer on the nanocapsule plays an important role in facilitating the electrostatic stabilization of the CPEC nanocapsule in water. These finding suggest that CS could potentially be utilized as an electrostatic stabilizer.

The particle size and zeta potential of CE and CPE nanocomplex are shown FIG. 9B. The average particle sizes of pristine CNC and CNC/PVP were 104.3 and 218.8 nm, respectively. PVP coating on CNC almost doubled the particle size. However, when a larger amount of EMB was loaded, the average particle size of CE became bigger than CPE nanoparticles. For example, when 80 mg of EMB was loaded, the average particle size of CE and CPE was 641.3 and 504 nm, respectively. The zeta potential of pristine CNC and CNC/PVP nanocapsule was −52.2±6 and −44±7 mV. PVP coating slightly increased the zeta potential, which indicates increased hydrophobicity, supporting previous observations. When more EMB was loaded onto CNC and CNC/PVP, the zeta potential of the system also increased toward zero. FIG. 9C demonstrates the particle size and zeta potential analysis of CEC and CPEC nanocapsule after CS coating. When anionic CNC and CNC/PVP were coated with cationic CS polymer, the particle size steadily increased due to strong electrostatic interactions.^{[26]} The system aggregated at 1:25 mass ratio, forming a macro-gel with an average particle size greater than 2 μm. The sample at 1:17 mass ratio exhibited similar aggregation, where the particle size was larger than 1 μm. This aggregation was associated to the zeta potential of the system approaching 0 mV, where the nanoparticles became neutral and aggregated due to the loss of the electrostatic repulsion. However, when more CS (at 1:13 ratio, CS:CNC, w/w) was added to the system, the zeta potential became positive, approaching +35.7±4 mV, thereby stabilizing the complex and yielding an average particle size lower than 700 nm. Interestingly, at a mass ratio of 1:10 (CS:CNC, w/w), the average particle size of CPEC reduced down to 200.1 nm, while maintaining a positive zeta potential of +41.5±9 mV. The addition of CS beyond this increased the average particle size of CPEC up to 491.7 nm at a 1:1.3 mass ratio, and the zeta potential remained positive at +48.73±6 mV. These results indicate that mass ratio plays a significant role in controlling the particle size and zeta potential of CPC and CPEC. In terms of the physical characteristics of CEC and CPEC, a 1:10 mass ratio between CS and CNC was the optimal condition for targeted drug delivery to the mucus membrane due to colloidal stability and particle size. It was also shown that PVP reduced the particle size at various mass ratios, particularly for the 1:25 and 1:17 mass ratio (CS:CNC, w/w), where significant aggregation occurred.

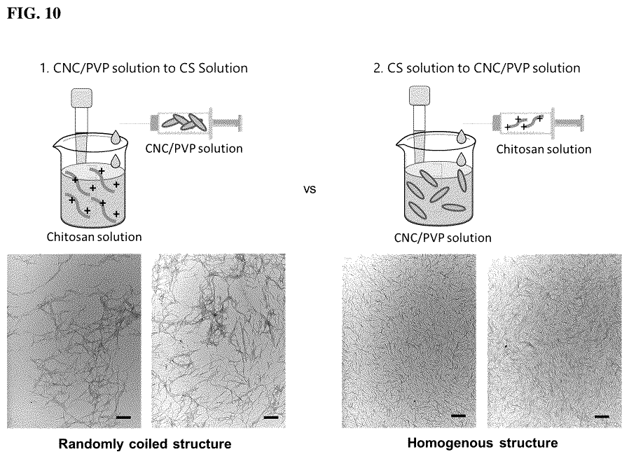

Different morphologies of the modified CPEC nanocapsules were observed depending on the synthetic protocols at the same injection speed (1.5 mL/min) (FIG. 10). When the CNC/PVP solution was slowly introduced into the glycidyltrimethylammonium chloride-chitosan (Gch) solution under sonication, the TEM image of the modified CPEC showed that the nanocapsule possessed an irregular random-coil structure (FIG. 10-1). However, when the Gch solution was introduced into the CNC/PVP solution at the same injection speed, a homogenous Gch coating on the CNC/PVP nanoparticles was observed (FIG. 10-2). In Protocol 1, the CNC/PVP nanoparticles exhibited a randomly coiled structure because the excess Gch randomly coated the nanoparticles via strong electrostatic interactions. However, when a small amount of Gch polymer was injected into the CNC/PVP solution (Protocol 2), the Gch was evenly coated on the individual nanoparticles, suggesting that the order of adding the polymer had a significant impact on the morphology of the nanocapsule. Introducing the chitosan polymer into the CNC/PVP nanoparticle solution is a better way to obtain a homogenous morphology. This finding may apply to syntheses for other nanoparticles comprised of a rigid particle and polymer, with opposite surface charges to each other. A flexible polymeric structures can entangle more easily with rigid nanoparticles, thus small amounts of polymeric agent should be carefully introduced to rigid particles to obtain a homogenous coating. Additionally, the concentration of the polymer and nanoparticles, sonication power, and injection speeds are several important factors to consider when preparing a homogenous coated nanostructure.

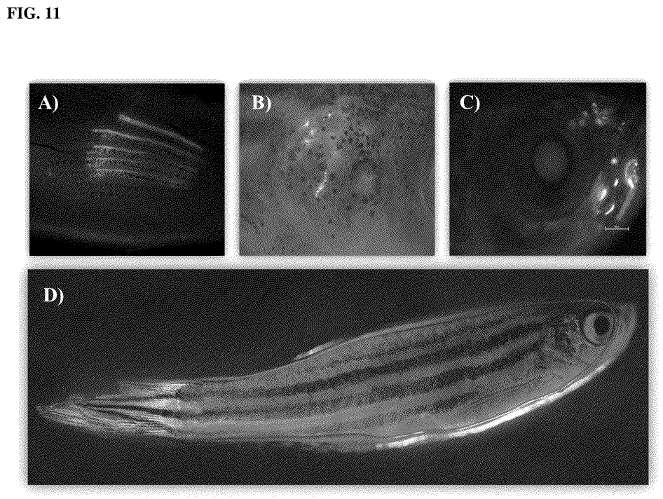

The mucoadhesive properties of the CPEC nanocapsule were studied using zebrafish as an animal model. After 30 mins of exposure to the CPC-f, the zebrafish were anesthetized and washed several times to remove unbound nanoparticles that may have remained on the surface of fish skin. The fluorescence images of zebrafish skin shows that labelled CPC bind to live zebrafish mucus (FIG. 11A-D). It was observed that the CPEC nanocapsule specifically bound to the horizontal lines of zebra fish tails (FIG. 11A). CPEC nanocapsules bind to the zebra fish surface via electrostatic interaction and hydrogen bonding. The abundant hydroxyl groups of CNC and CS can form hydrogen bonds with the mucus. Furthermore, cationic CS polymers are probably attracted to the negatively charged mucin protein present in zebrafish mucus.

### Example 9: Azoxystrobin-SDS/PCNC Formulation Preparation and Droplet Impact Test

The preparation of Azoxystrobin-SDS/PCNC formulation is described below:
a. 2 mL of PADAMAC (20 wt % solution in water) is added to 400 mL 0.1 wt % of CNC dispersion magnetically stirring for 24 h.
b. Ultrafiltration of the mixture from step (a) to obtain the PCNC dispersion.
c. 5 g of the PCNC dispersion from step (b) is freeze-dried and the powder weight is measured to determine the concentration. For example, the concentration of PCNC dispersion is 0.5 wt %.
d. Dissolve 0.8 g of SDS in 7.2 mL of water.
e. Add 0.1 mL of SDS solution from step (d) into 9.9 mL 0.5 wt % of PCNC dispersion from step (b) under stirring and reacting for 5 h to obtain SDS/PCNC complexes.
f. Add 10 mg of Azoxytrobin powder into complexes from step (e) and stir for 12 h.

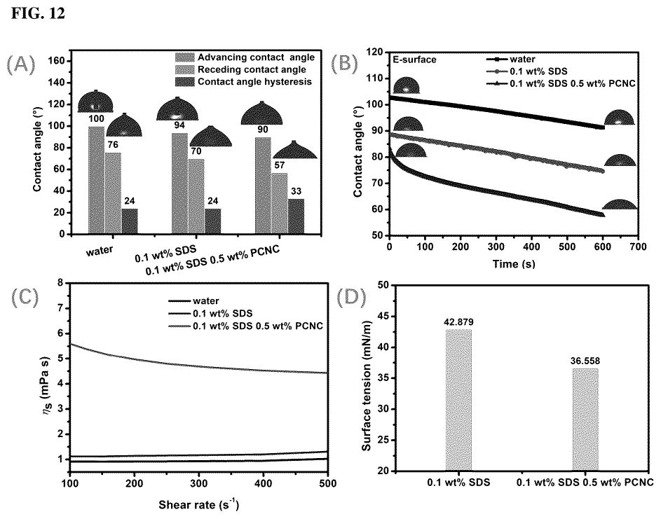

The advancing and receding contact angle and changes in the contact angle as a function of time of SDS/PCNC complexes on eggplant surface is measured using the OCA 15 (Dataphysics), as shown is FIGS. 12A and 12B. It is obvious that the contact angle hysteresis of SDS/PCNC complexes is the largest, revealing that the increased retention force on eggplant skin. Besides, contact angle of SDS/PCNC complexes on eggplant skin is the smallest at beginning and displays a larger decrease over the same time compared with SDS and water. The viscosity and surface tension are measured by Kinexus rheometer (Malvern) and DCAT 11 tensiometer (Dataphysics). The results are shown in FIGS. 12C and 12D, the viscosity of SDS/PCNC complexes increase and the surface tension decreases, which is favorable for the deposition on hydrophobic surface.

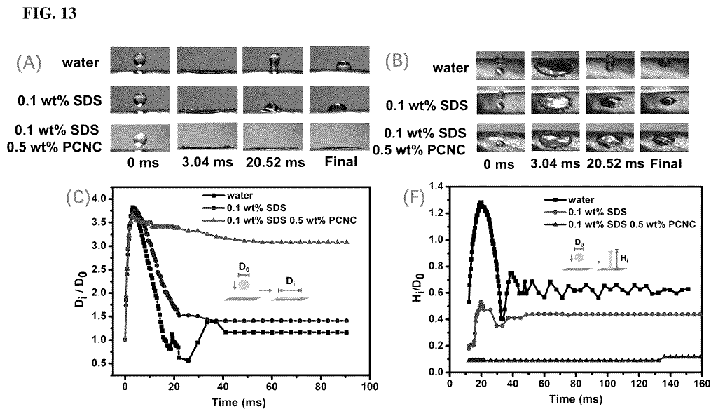

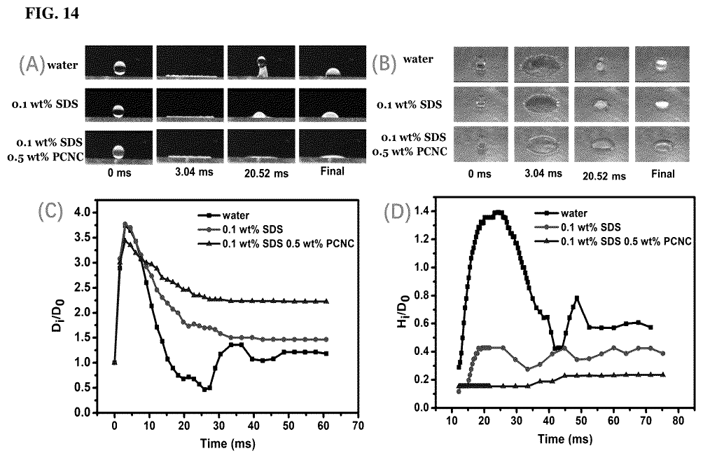

The droplet impact of SDS/PCNC complexes on eggplant skin is shown in FIGS. 13A and 13B, it is obvious that SDS/PCNC spread well on the eggplant skin without evidence of droplet rebound. The diameter and rebound height of droplet are measured using Image J, as presented in FIGS. 13C and 13D. It can be seen that SDS/PCNC inhibits the shrinkage and rebound of droplet on eggplant skin. Similar phenomena are observed when it impact on other hydrophobic surfaces produced by beeswax/SDS emulsion, as shown in FIGS. 14A, 14B, 14C and 14D.

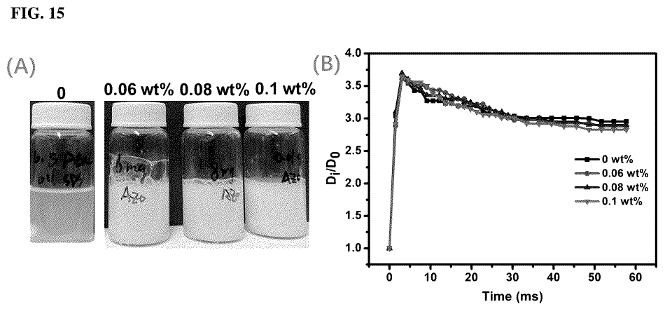

The visual picture of Azoxystrobin-SDS/PCNC formulation with different concentrations of Azoxystrobin are presented by FIG. 15A. The droplet diameter on eggplant skin is shown in FIG. 15B, it is obvious the Azoxystrobin-SDS/PCNC formulation deposited well on eggplant skin. High speed camera images (data not shown) shows the Azoxystrobin-SDS/PCNC formulation with different concentration impacting on eggplant with the speed of 2.4 m/s, and shows that the formulation spreads well on eggplant surface.

### Additional Embodiments

A method of controlling a pest species comprising the steps of:
a. dispersing an effective amount of the biomass-based nano-dispersion of a hydrophobic agrochemical of claim 1 in water; and
b. treating or applying the dispersion from (a) to a surface or to a pest species, wherein the treatment is effective to kill or inhibit pest infestation.

The method of [0145], wherein the surface is a plant or animal surface.

A method for preparing an agrochemical formulation comprising the steps of:
a. Admixing a cationic polymer solution and a CNC dispersion;
b. Removing unreacted cationic polymer to obtain a polymer-modified CNC dispersion (PCNC dispersion);
c. Optionally, adding a surfactant solution to the PCNC dispersion to form surfactant/PCNC complexes; and
d. Adding to (b) or (c) an agrochemical and mixing to form agrochemical-loaded surfactant/PCNC particles.

The method of any of the preceding paragraphs, wherein the agrochemical is selected from the group consisting of Emamectin benzoate (CAS No. 155569-91-8), β-Cyfluthrin (CAS No. 68359-37-5), Azoxystrobin (CAS No. 131860-33-8) Difenoconazole (CAS No. 119446-68-3), Deltamethrin (CAS No. 52918-63-5), Permethrin (CAS No. 52645-53-1), Thiamethoxam (CAS No. 153719-23-4), 2,4-Dichlorophenoxyacetic acid (CAS No. 7084-86-8), and a combination thereof.

The method of any of the preceding paragraphs, wherein the cationic polymer comprises at least one of Polydiallyldimethylammonium chloride PADAMAC, branched and linear polyethylenimine (PEI), cationic cellulose, gelatin, dextran, polylysine, or poly[2-(dimethylamino)ethyl methacrylate] (PDMAEMA) or a combination thereof.

The method of any of the preceding paragraphs, wherein the cationic polymer is PADAMAC.

The method of any of the preceding paragraphs, wherein the mass ratio (w/w) of PADAMAC to CNC is from about 1:10 to about 10:1.

The method of any of the preceding paragraphs, wherein the surfactant comprises at least one of an anionic surfactant, a cationic surfactant, a non-ionic surfactant, a zwitterionic surfactant or a combination thereof.

The method of any of the preceding paragraphs, wherein the surfactant comprises at least one of ammonium lauryl sulfate, sodium laureth sulfate, sodium lauryl sarcosinate, sodium myreth sulfate, sodium pareth sulfate, sodium stearte, sodium lauryl sulfate, a olefin sulfonate, and ammonium laureth sulfate, trimethylalkylammonium chlorides, and the chlorides or bromides of benzalkonium and alkylpyridinium ions, fatty alcohol ethoxylate, alkyl phenol ethoxylate and fatty acid alkoxylate or a combination thereof.

The method of any of the preceding paragraphs, wherein the mass ratio (w/w) of surfactant to PCNC is from about 1:5 to about 5:1.

The method of any of the preceding paragraphs, wherein the surfactant is sodium laureth sulfate (SDS).

The method of any of the preceding paragraphs, wherein the CNC comprises at least one of a sulfated CNC, glycidyltrimethylammonium chloride (GTMAC) grafted CNC, QUAB modified CNC or a combination thereof.

The method of any of the preceding paragraphs, wherein the method further comprises the step of applying the agrochemical-loaded surfactant/PCNC particles to a plant surface, modified plant surface or skin of marine animal.

The method of any of the preceding paragraphs, wherein the modified plant surface comprises a plant surface treated with a beeswax/SDS emulsion.

An agrochemical-loaded surfactant/PCNC particle formed according to the method of any of the preceding paragraphs.

### REFERENCES

The following references are incorporated herein by reference in their entirety for all purposes. ADDIN NE.Bib
[1] Nuruzzaman M, Rahman M M, Liu Y, et al. Nanoencapsulation, Nano-guard for Pesticides: A New Window for Safe Application[J]. J Agric Food Chem, 2016, 64(7):1447-1483. https://doi.org/10.1021/acs.jafc.5b05214.
[2] Chih-Ping Chin H W S S. New Approach to Pesticide Delivery Using NanosuspensionsResearch and Applications[J]. Ind. Eng. Chem. Res., 2011(50):7637-7643. https://doi.org/10.1021/ie2001007.
[3] Zhao X, Cui H, Wang Y, et al. Development Strategies and Prospects of Nano-based Smart Pesticide Formulation[J]. J Agric Food Chem, 2018, 66(26):6504-6512. https://doi.org/10.1021/acs.jafc.7b02004.
[4] Cui P F, Zhuang W R, Hu X, et al. A new strategy for hydrophobic drug delivery using a hydrophilic polymer equipped with stacking units[J]. Chem Commun (Camb), 2018, 54(59):8218-8221. https://doi.org/10.1039/c8cc04363a.
[5] Yang D, Cui B, Wang C, et al. Preparation and Characterization of Emamectin Benzoate Solid Nanodispersion[J]. Journal of nanomaterials, 2017, 2017:1-9. https://doi.org/10.1155/2017/6560780.
[6] Shoaib A, Waqas M, Elabasy A, et al. Preparation and characterization of emamectin benzoate nanoformulations based on colloidal delivery systems and use in controlling Plutella xylostella (L.) (Lepidoptera: Plutellidae)[J]. RSC Adv, 2018, 8(28):15687-15697. https://doi.org/10.1039/C8RA01913D.
[7] Wang Y, Wang A, Wang C, et al. Synthesis and characterization of emamectin-benzoate slow-release microspheres with different surfactants[J]. Sci Rep, 2017, 7(1):12761. https://doi.org/10.1038/s41598-017-12724-6.
[8] Athanassiou C G, Kavallieratos N G, Benelli G, et al. Nanoparticles for pest control: current status and future perspectives[J]. Journal of pest science, 2018, 91(1):1-15. https://doi.org/10.1007/s10340-017-0898-0.
[9] Chen K, Fu Z, Wang M, et al. Preparation and Characterization of Size-Controlled Nanoparticles for High-Loading lambda-Cyhalothrin Delivery through Flash Nanoprecipitation[J]. J Agric Food Chem, 2018, 66(31):8246-8252. https://doi.org/10.1021/acs.jafc.8b02851
[10] Wang C, Cui B, Zhao X, et al. Optimization and characterization of lambda-cyhalothrin solid nanodispersion by self-dispersing method[J]. Pest Manag Sci, 2019, 75(2):380-389. https://doi.org/10.1002/ps.5122.
[11] Qin H, Zhang H, Li L, et al. Preparation and properties of lambda-cyhalothrin/polyurethane drug-loaded nanoemulsions[J]. RSC advances, 2017, 7(83):52684-52693. https://doi.org/10.1039/c7ra10640h.
[12] Li Y, Zhou M, Pang Y, et al. Lignin-Based Microsphere: Preparation and Performance on Encapsulating the Pesticide Avermectin[J]. ACS sustainable chemistry & engineering, 2017, 5(4):3321-3328. https://doi.org/10.1021/acssuschemeng.6b03180.
[13] Chi Y, Zhang G, Xiang Y, et al. Fabrication of a Temperature-Controlled-Release Herbicide Using a Nanocomposite[J]. ACS sustainable chemistry & engineering, 2017, 5(6):4969-4975. https://doi.org/10.1021/acssuschemeng.7b00348.
[14] Yusoff S N M, Kamari A, Aljafree N F A. A review of materials used as carrier agents in pesticide formulations[J]. International journal of environmental science and technology (Tehran), 2016, 13(12):2977-2994. https://doi.org/10.1007/s13762-016-1096-y.
[15] Sharma S, Singh S, Ganguli A K, et al. Anti-drift nano-stickers made of graphene oxide for targeted pesticide delivery and crop pest control[J]. Carbon, 2017, 115:781-790. https://doi.org/10.1016/j.carbon.2017.01.075.
[16] Chi K, Catchmark J M. Crystalline nanocellulose/lauric arginate complexes[J]. Carbohydrate Polymers, 2017, 175:320-329. https://doi.org/10.1016/j.carbpol.2017.08.005.
[17] Lixiong Wen Z L H Z. Controlled release of avermectin from porous hollow silica nanoparticles[J]. Pest Management Science, 2005(61):583-590. https://doi.org/10.1002/ps.1032.
[18] Tang C, Li Y, Pun J, et al. Polydopamine microcapsules from cellulose nanocrystal stabilized Pickering emulsions for essential oil and pesticide encapsulation[J]. Colloids and Surfaces A: Physicochemical and Engineering Aspects, 2019, 570:403-413. https://doi.org/10.1016/j.colsurfa.2019.03.049.
[19] Li Z, Ma Y, Zhao K, et al. Regulating Droplet Impact and Wetting Behaviors on Hydrophobic Weed Leaves by a Double-Chain Cationic Surfactant[J]. ACS sustainable chemistry & engineering, 2021, 9(7):2891-2901. https://doi.org/10.1021/acssuschemeng.0c08883.
[20] Song M, Ju J, Luo S, et al. Controlling liquid splash on superhydrophobic surfaces by a vesicle surfactant[J]. Sci Adv, 2017, 3(3):e1602188. DOI: 10.1126/sciadv.1602188.
[21] Zhang F, Islam M S, Berry R M, et al. beta-Cyclodextrin-Functionalized Cellulose Nanocrystals and Their Interactions with Surfactants[J]. ACS Omega, 2019, 4(1):2102-2110. https://doi.org/10.1021/acsomega.8b02534.
[22] Moon R J, Martini A, Nairn J, et al. Cellulose nanomaterials review: structure, properties and nanocomposites[J]. Chemical Society reviews, 2011, 4(7):3941-3994. https://doi.org/10.1039/c0cs00108b.
[23] Tang C, Spinney S, Shi Z, et al. Amphiphilic Cellulose Nanocrystals for Enhanced Pickering Emulsion Stabilization[J]. Langmuir, 2018, 34(43): 12897-12905. https://doi.org/10.1021/acs.langmuir.8b02437.
[24] Lin N, Huang J, Dufresne A. Preparation, properties and applications of polysaccharide nanocrystals in advanced functional nanomaterials: a review[J]. Nanoscale, 2012, 4(11):3274-3294. https://doi.org/10.1039/C2NR30260H.
[25] Wu X, Tang J, Duan Y, et al. Conductive cellulose nanocrystals with high cycling stability for supercapacitor applications[J]. Journal of materials chemistry. A, Materials for energy and sustainability, 2014, 2(45):19268-19274. https://doi.org/10.1039/c4ta04929b.
[26] Berestok T, Guardia P, Ibanez M, et al. Electrostatic-Driven Gelation of Colloidal Nanocrystals[J]. Langmuir, 2018, 34(31):9167-9174. https://doi.org/10.1021/acs.langmuir.8b01111.

1. A method of preparing a biomass-based nano-dispersion of a hydrophobic agrochemical comprising the steps of:
a. dissolving the hydrophobic agrochemical in at least one organic solvent;
b. dispersing biomass-based particles in an aqueous solution or at least one organic solvent;
c. mixing the solution from (a) and dispersion from (b);
d. removing the organic solvents to form an agrochecmical-biomass based product; and
e. optionally, dispersing the agrochemical-biomass based product from (d) in water.

2. The method of claim 1, wherein the at least one organic solvent comprises at least one of acetone, chloroform, ethanol, methanol, hexane or a combination thereof.

3. The method of claim 1, wherein the biomass-based particles are micro- or nano-particles comprising at least one of chitosan (CS), lignin, chitin, cellulose, a polysaccharide, derivatives of the same, or a combination thereof.

4. The method of claim 1, wherein step (d) includes removing the organic solvents by at least one of heating, vacuum, spray-drying, freeze-drying or a combination thereof.

5. The method of claim 1, wherein the hydrophobic agrochemical comprises at least one of a pesticide, fungicide, herbicide, or a combination thereof for agriculture or aquaculture.

6. The method of claim 5, wherein the agrochemical is selected from the group consisting of Emamectin benzoate (CAS No. 155569-91-8), β-Cyfluthrin (CAS No. 68359-37-5), Azoxystrobin (CAS No. 131860-33-8) Difenoconazole (CAS No. 119446-68-3), Deltamethrin (CAS No. 52918-63-5), Permethrin (CAS No. 52645-53-1), Thiamethoxam (CAS No. 153719-23-4), 2,4-Dichlorophenoxyacetic acid (CAS No. 7084-86-8), and a combination thereof.

7. The method of claim 3, wherein the biomass-based particles comprise at least one of cellulose nanocrystals (CNCs), cellulose microcrystals, lignin micro/nanoparticles, starch micro/nanocrystals or a combination thereof.

8. The method of claim 7, wherein the biomass-based particles comprise a combination of CNC and CS.

9. The method of claim 7, wherein the ratio of CS to CNC (w/w) is between about 1:1 to about 1:50.

10. The method of claim 9, wherein the CNC/CS particles are mucoadhesive nanoparticles having a size of from about 200 nm to about 2 microns.

11. The method of claim 10, wherein the biomass-based particles further comprise polyvinylpyrrolidone (PVP).

12. The method of claim 11, wherein the biomass-based particles further comprise mucin.

13. The method of claim 1, wherein the amount of hydrophobic agrochemical is from about greater than zero wt % to less than 100 wt % relative to the weight of the at least one organic solvent solution in step (a).

14. The method of claim 1, wherein the amount of hydrophobic agrochemical is from about 0.1 wt % to about 10.0 wt % relative to the weight of the at least one organic solvent solution in step (a).

15. The method of claim 1, wherein the amount of CNC is from about 0.01 wt % to about 10.0 wt % relative to the weight of the solvent in the dispersion in step (b).

16. The method of claim 1, wherein the amount of CNC is from about 0.25 wt % to about 3.0 wt % relative to the weight of the solvent dispersion in step (b).

17. The method of claim 1, wherein the amount of CNC is from about 1.0 wt % to about 20.0 wt % relative to the weight of the at least one organic solvent in the dispersion in step (b).

18. The method of claim 1, wherein the amount of agrochemical in the agrochecmical-biomass based product is between about 5 wt % to about 20 wt % relative to the total weight.

19. A biomass-based nano-dispersion of a hydrophobic agrochemical formed according to the process of claim 10.

20. A biomass-based nano-dispersion of a hydrophobic agrochemical formed according to the process of claim 11.
